(19) United States
(12) Patent Application Publication
(10) Pub. No.: US 2015/0208072 A1
(43) Pub. Date: Jul. 23, 2015

(54) ADAPTIVE VIDEO COMPRESSION BASED ON MOTION

(71) Applicant: NVIDIA CORPORATION, Santa Clara, CA (US)

(72) Inventor: Jianjun CHEN, Shanghai (CN)

(73) Assignee: NVIDIA CORPORATION, Santa Clara, CA (US)

(21) Appl. No.: 14/161,435

(22) Filed: Jan. 22, 2014

(51) Int. Cl. H04N 19/137

(52) U.S. Cl. CPC H04N 19/137; H04N 19/105; H04N 19/172; H04N 19/577

(57) ABSTRACT

One embodiment of the present invention sets forth a technique for adaptively compressing video frames. The technique includes monitoring a motion vector associated with a video stream and encoding a first plurality of video frames included in the video stream based on a first video compression algorithm to generate first encoded video frames. The technique further includes determining that the motion vector has reached a threshold level and, in response, switching from the first video compression algorithm to a second video compression algorithm. The technique further includes encoding a second plurality of video frames included in the video stream based on the second video compression algorithm to generate second encoded video frames. Advantageously, the disclosed technique enables a video compression algorithm to be dynamically selected based on an amount of motion detected in a video stream that is to be compressed.

### BACKGROUND OF THE INVENTION

1. Field of the Invention

Embodiments of the present invention generally relate to video processing and, more specifically, to adaptive video compression based on motion.

2. Description of the Related Art

Video compression techniques generally enable the data rate of a video stream to be reduced without significantly affecting picture quality. As a result, high-quality video can be stored using a smaller amount of memory and/or can be transmitted over a network using less bandwidth. Additionally, video compression enables high-quality graphical user interface (GUI) images to be transmitted over a network to a user more quickly, allowing the user to interact with the GUI substantially in real-time.

In general, lossy video compression algorithms compress video frame data by detecting similarities between macroblocks or coding tree units in a given video frame and macroblocks or coding tree units in one or more preceding and/or subsequent video frames. For example, an inter-frame compression algorithm may detect similarities and differences between macroblocks in a current video frame and macroblocks in a preceding video frame and/or a subsequent video frame. The inter-frame compression algorithm may then encode the current video frame by storing the differences between the preceding video frame and the current video frame and/or the differences between the subsequent video frame and the current video frame.

Although inter-frame compression algorithms allow the data rate of a video stream to be significantly reduced, when certain types of video streams are encoded, inter-frame compression algorithms may be unable to effectively detect similarities and differences between a current video frame and a preceding video frame and/or between a current video frame and a subsequent video frame. Under such circumstances, the inter-frame compression algorithm may reference an incorrect portion of a preceding video frame and/or subsequent video frame, causing a noticeable reduction in the picture quality of the resulting compressed video stream.

As the foregoing illustrates, there is a need in the art for a more effective way to select and apply compression algorithms to a stream of video data.

### SUMMARY OF THE INVENTION

One embodiment of the present invention sets forth a method for adaptively compressing video frames. The method includes monitoring a motion vector associated with a video stream and encoding a first plurality of video frames included in the video stream based on a first video compression algorithm to generate first encoded video frames. The method further includes determining that the motion vector has reached a threshold level and, in response, switching from the first video compression algorithm to a second video compression algorithm. The method further includes encoding a second plurality of video frames included in the video stream based on the second video compression algorithm to generate second encoded video frames.

Further embodiments provide, among other things, a non-transitory computer-readable medium and a computing device configured to carry out method steps set forth above.

Advantageously, the disclosed technique enables a video compression algorithm to be dynamically selected based on an amount of motion detected in a video stream that is to be compressed. Accordingly, a high-quality image is maintained, even when there is a relatively high degree of motion in the video stream. Additionally, a higher-compression ratio algorithm may be selected and applied when there is a relatively low degree of motion in the video stream.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a system configured to implement one or more aspects of the present invention;

FIG. 2 is a block diagram of a parallel processing unit (PPU) included in the parallel processing subsystem of FIG. 1, according to one embodiment of the present invention;

FIG. 3 is a block diagram of the encoder included in the PPU of FIG. 2, according to one embodiment of the present invention;

FIGS. 4A-4C illustrate video frames arranged in order of display when encoded based on intra-frame and inter-frame compression algorithms , according to one embodiment of the present invention;

FIG. 5 illustrates encoded video frames generated when switching between a first video compression algorithm and a second video compression algorithm, according to one embodiment of the present invention; and

FIG. 6 is a flow diagram of method steps for adaptively compressing video frames, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

### System Overview

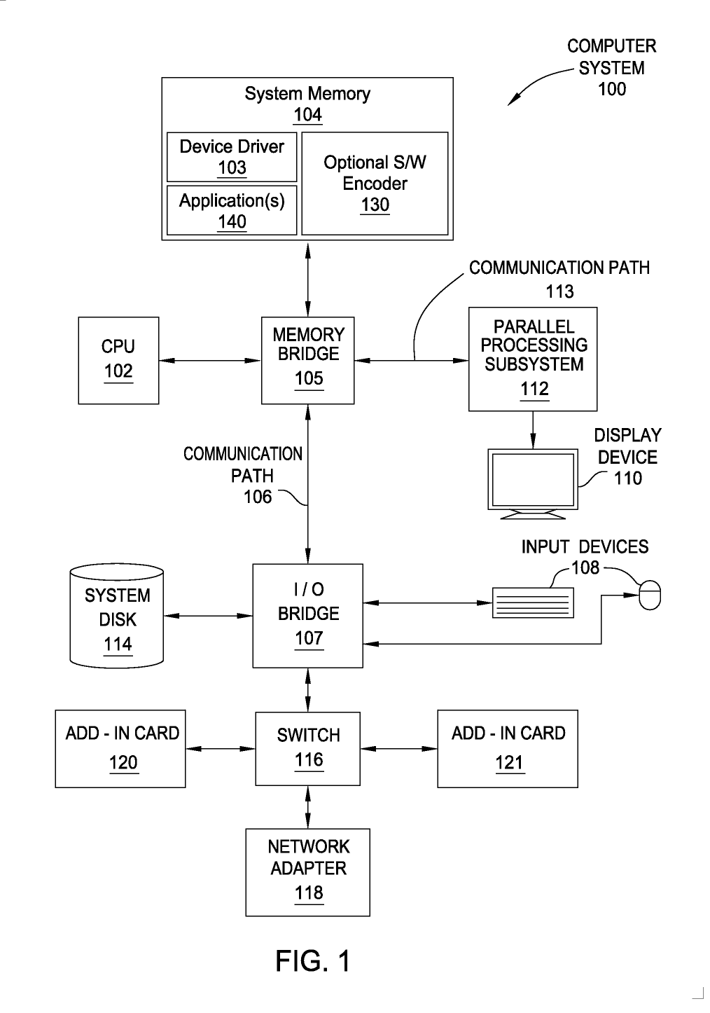

FIG. 1 illustrates a system configured to implement one or more aspects of the present invention. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In operation, I/O bridge 107 is configured to receive user input information from input devices 108, such as a keyboard or a mouse, and forward the input information to CPU 102 for processing via communication path 106 and memory bridge 105. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbrige chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

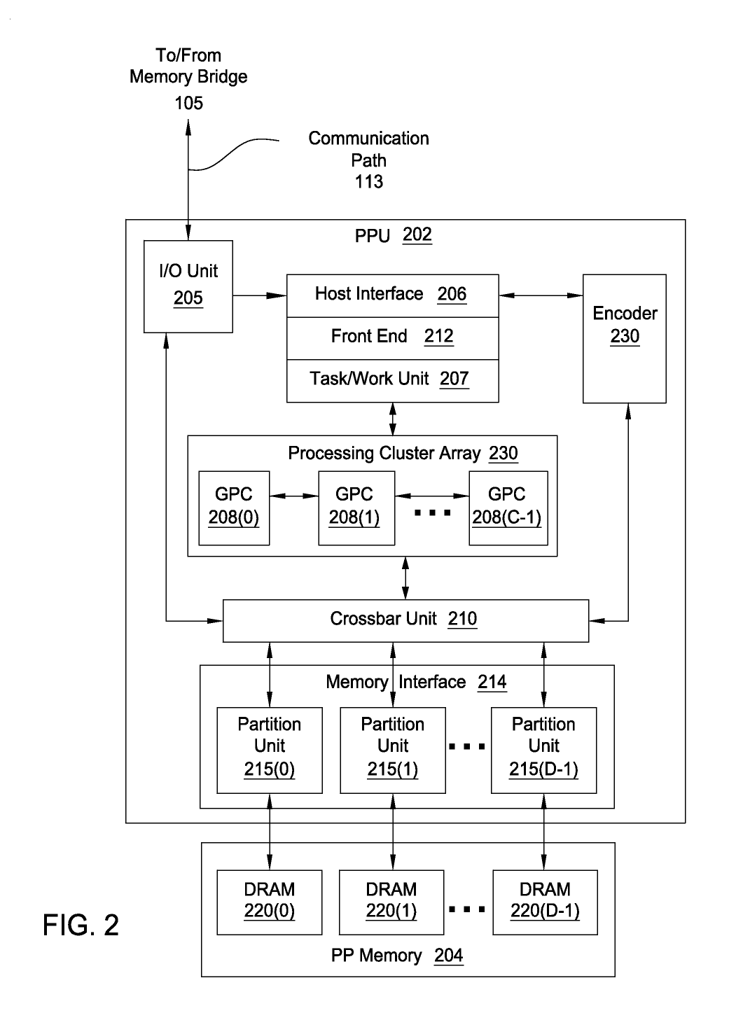

In some embodiments, parallel processing subsystem 112 comprises a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in FIG. 2, such circuitry may be incorporated across one or more parallel processing units (PPUs) included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations.

System memory 104 includes at least one device driver 103 configured to manage the processing operations of the one or more PPUs within parallel processing subsystem 112. System memory 104 may further include an optional software encoder 130 and one or more applications 140. The optional software encoder 130 is configured to receive and encode images, such as graphical user interface (GUI) images, video streams, and the like, to generate encoded video frames.

In various embodiments, parallel processing subsystem 112 may be integrated with one or more other elements of FIG. 1 to form a single system. For example, parallel processing subsystem 112 may be integrated with CPU 102 and other connection circuitry on a single chip to form a system-on-chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) included in the parallel processing subsystem of FIG. 1, according to one embodiment of the present invention. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computer system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computer system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end unit 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C≧1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D≧1. Each partition unit 215 is coupled to one or more dynamic random access memories (DRAMs) 220 residing within PPM memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPCs 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

As noted above, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

PPU 202 may include an encoder 230 that receives processing tasks from the host interface 206 and communicates with memory interface 214 via crossbar unit 210 to read from and/or write to the DRAMs 220. For example, the encoder 230 may be configured to read frame data (e.g., YUV or RGB pixel data) from the DRAMs 220 and apply a video compression algorithm to the frame data to generate encoded video frames. Encoded video frames may then be stored in the PP memory 204 and/or transmitted through the crossbar unit 210 to the I/O Unit 205.

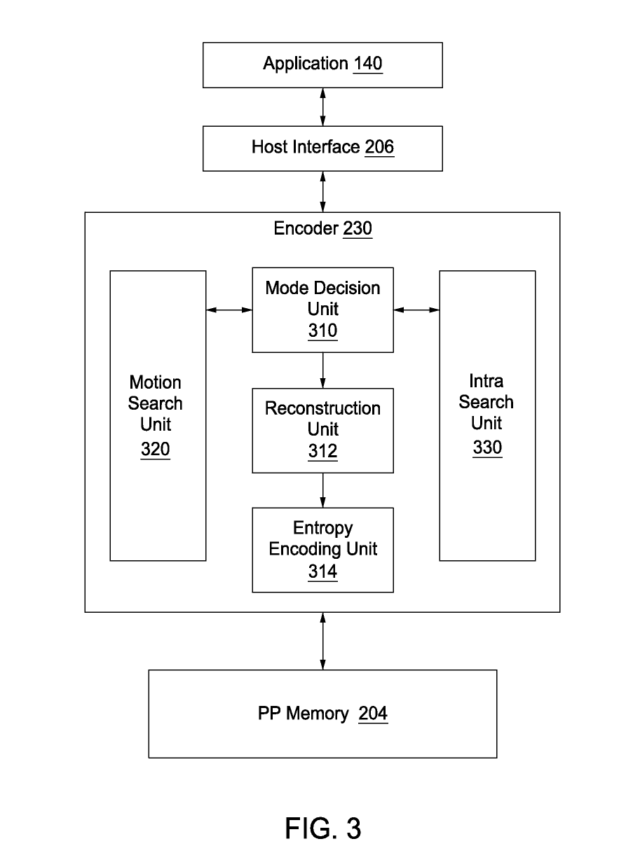

FIG. 3 is a block diagram of the encoder included in the PPU of FIG. 2, according to one embodiment of the present invention. The encoder 230 includes a mode decision unit 310 that selects a video compression algorithm to be applied video frame data. The mode decision unit 310 may select a video compression algorithm based on various types of video frame statistics, such as motion vectors, received from the motion search unit 320 and/or the intra search unit 330. The encoder 230 further includes a reconstruction unit 312 and an entropy encoding unit 314. The reconstruction unit 312 may be configured to process and combine inter-frame and intra-frame compression data to construct a compressed frame data. The entropy encoding unit 314 may be configured to further compress the frame data by assigning one or more codes to unique symbols included in the frame data.

The encoder 230 may be configured to encode frame data based on different video compression algorithms, such as H.263, H.264, VP8, High Efficiency Video Coding (HEVC), and the like. In general, lossy video compression algorithms compress frame data using a combination of intra-frame compression algorithms and inter-frame compression algorithms. Intra-frame compression algorithms reduce video data rate by compressing individual video frames in isolation, without reference to preceding video frames or subsequent video frames. For example, the intra search unit 330 may detect similarities between macroblocks (e.g., 16×16 pixel blocks) or coding tree units included in a single video frame. The encoder 230 may then apply an intra-frame compression algorithm to perform spatial compression by consolidating these similarities, reducing the size of the video frame without significantly affecting the visual quality of the video frame.

In contrast, inter-frame compression algorithms reduce video data rate by detecting similarities between macroblocks or coding tree units in a given video frame and macroblocks or coding tree units in one or more preceding video frames and/or subsequent video frames. For example, the motion search unit 320 may detect similarities and differences between macroblocks in a current video frame and macroblocks in a preceding video frame. The encoder 230 may then apply an inter-frame compression algorithm to the current video frame by storing what has changed between the preceding video frame and the current video frame and consolidating frame data that is similar between the preceding video frame and the current video frame. That is, the current video frame is encoded with reference to the preceding video frame. This technique is commonly referred to as predictive frame (P-frame) encoding.

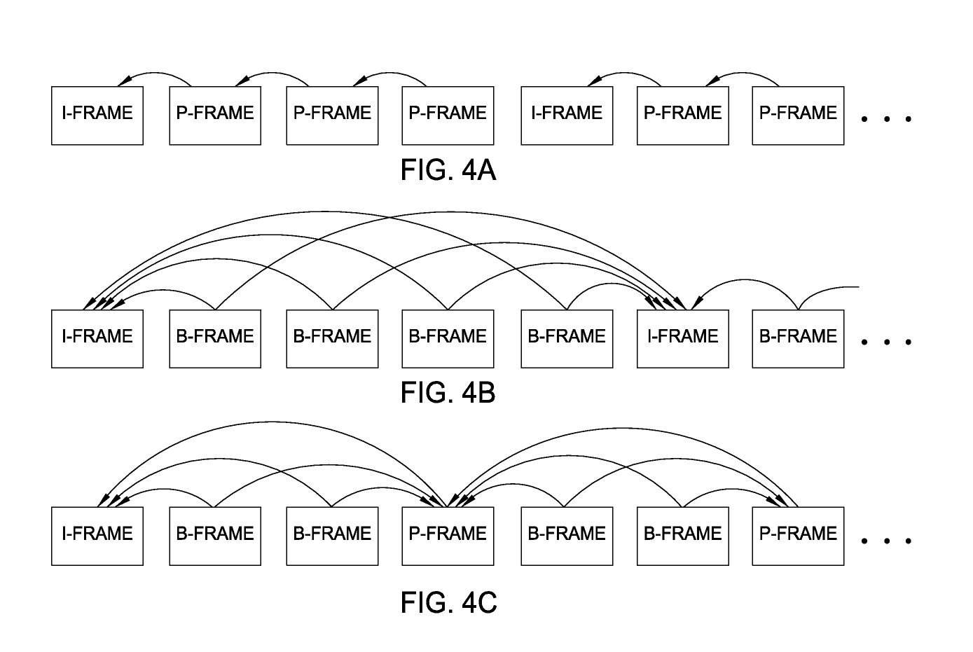

Additionally, when applying another type of inter-frame compression algorithm, the motion search unit 320 may detect similarities and differences between macroblocks in a current video frame and macroblocks in both a preceding video frame and a subsequent video frame. The encoder 230 may then apply the inter-frame compression algorithm to the current video frame by storing the differences between the preceding video frame and the current video frame as well as the differences between the subsequent video frame and the current video frame. Additionally, frame data that is similar between the preceding video frame and the current video frame as well as between the subsequent video frame and the current video frame may be consolidated. This technique is commonly referred to as bi-directional frame (B-frame) encoding. Exemplary video frames encoded based on intra-frame and inter-frame compression algorithms are described in further detail below in conjunction with FIGS. 4A-4C.

In general, the motion search unit 320 may search for similarities included in two or more video frames within a specified search range. The search range indicates a distance from each macroblock that the motion search unit 320 will search for similarities between two or more video frames. The search range may be specified in units of pixels. For example, the motion search unit 320 may have a search range of 32×32 pixels, indicating that the motion search unit 320 will search for similarities (e.g., similar pixel values) between two video frames in a 16-pixel radius (e.g., −16 pixels to +16 pixels) from a given macroblock. In such an embodiment, the motion search unit 320 may then select a location (e.g., in a preceding or subsequent video frame) within the 32×32 pixel search range that is a closest match to a macroblock being processed (e.g., in the current video frame).

In addition to detecting the location(s) of similar pixels and/or macroblocks in preceding video frames and/or a subsequent video frames, the motion search unit 320 may further determine one or more motion vectors associated with the locations of these similarities. For example, the motion search unit 320 may determine that a particular object or portion of an object is located in a first location in one video frame and is located in a second location in a second video frame (e.g., the next video frame). The motion search unit 320 may then determine the distance between the first location and the second location (e.g., in units of pixels) to compute a motion vector. Further, the motion search unit 320 may compute multiple motion vectors for a given video frame and/or group of pictures (GOP). The motion vectors may then be averaged to determine an average motion vector that indicates the degree of motion associated with the video frame and/or the degree of motion associated with the GOP.

### Adaptive Video Compression Based On Motion

FIGS. 4A-4C illustrate video frames arranged in order of display when encoded based on intra-frame and inter-frame compression algorithms, according to one embodiment of the present invention. As shown, P-frames are encoded based on a preceding intra frame (I-frame) or P-frame. B-frames, on the other hand, are encoded based on both a preceding I-frame or P-frame and a subsequent I-frame or P-frame. In general, each series of encoded video frames begins with an I-frame that is referenced by subsequent P-frames and/or B-frames.

In FIG. 4A, each I-frame is followed by a plurality of P-frames when the encoded video frames are arranged in order of display. Each P-frame is encoded based on the preceding I-frame or P-frame. That is, each P-frame encodes the differences between the current video frame and the previous I-frame or P-frame. Accordingly, in general, P-frame compression algorithms are capable of accurately encoding video streams having a high degree of motion, since each video frame is encoded with reference to an adjacent video frame.

In FIG. 4B, each I-frame is followed by a plurality of B-frames when the encoded video frames are arranged in order of display. Each B-frame is encoded based on the preceding I-frame and the next I-frame. That is, each B-frame encodes the differences between the current video frame and the previous I-frame as well as the differences between the current video frame and the next I-frame. In FIG. 4C, each I-frame is followed by both B-frames and P-frames. As shown, each B-frame may be encoded based on the preceding reference frame (e.g., I-frame or P-frame) as well as the next reference frame.

By referencing both preceding and subsequent video frames, bi-directional video compression algorithms may significantly increase compression efficiency as compared to predictive encoding algorithms. However, because encoding is performed by referencing preceding and subsequent video frames, which may be several frames away from the current video frame, bi-directional compression algorithms may be unable to accurately encode video streams having a high degree of motion. For example, an object displayed in a current video frame that is moving at a relatively high speed in the video stream may be located at a first location in a current video frame and located a second location in a subsequent video frame (e.g., separated by several frames from the current video frame). However, if the subsequent video frame is referenced by the current video frame to perform B-frame encoding, the second location may be outside of the search range—relative to the first location—of the motion search unit 320. Consequently, when the current video frame is encoded with reference to this subsequent video frame, the motion search unit 320 may be unable to locate the object and, as a result, the encoder 230 may encode the current video frame with reference to an incorrect location in the subsequent video frame, reducing image quality and/or compression efficiency.

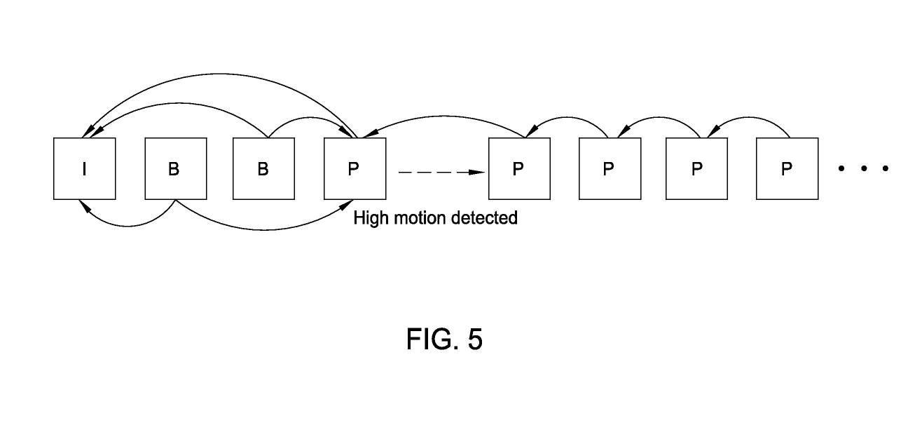

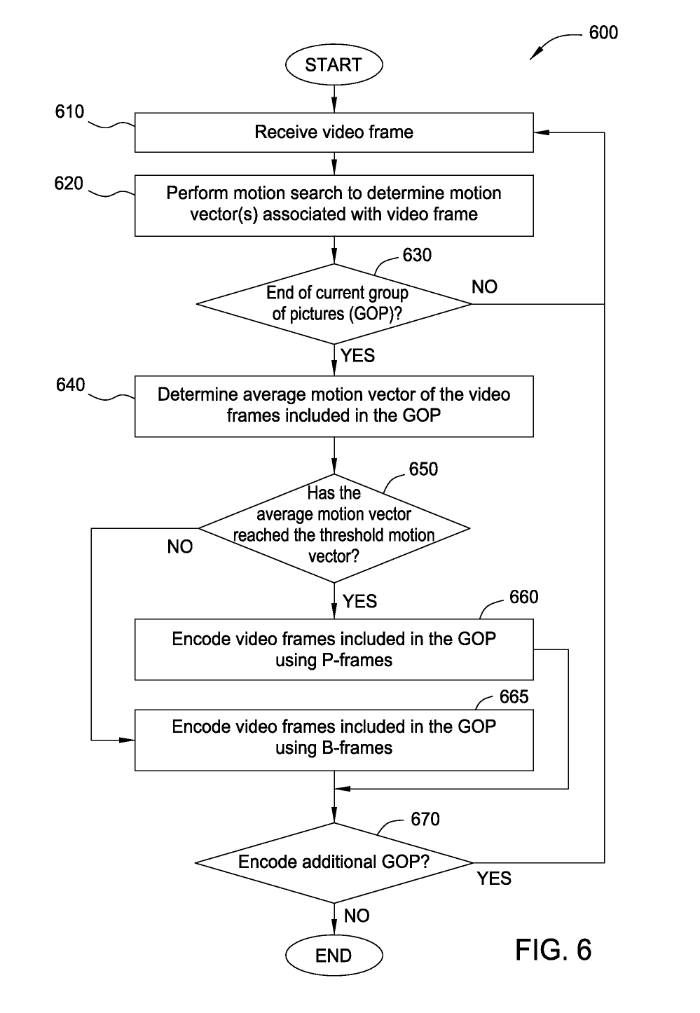

To address the shortcomings described above, in various embodiments, the motion search unit 320 may determine a motion vector that indicates the amount of motion included in one or more portions of a video stream. The mode decision unit 310 may then determine whether to enable or disable a bi-directional compression algorithm based on the motion vector. For example, if the motion vector indicates that there is a low degree of motion in a particular group of pictures (GOP), then the mode decision unit 310 may enable a bi-directional compression algorithm. On the other hand, if the motion vector indicates that there is a high degree of motion in a particular group of pictures (GOP), then the mode decision unit 310 may disable a bi-directional compression algorithm and instead use a P-frame compression algorithm. An exemplary method which implements this adaptive encoding technique is described below in conjunction with FIGS. 5 and 6.

FIG. 5 illustrates encoded video frames generated when switching between a first video compression algorithm and a second video compression algorithm, according to one embodiment of the present invention. As shown, the encoder 230 may process video frames by applying a bi-directional compression algorithm in order to generate a compressed video stream that includes B-frames. The decision to encode the video frames using a bi-directional compression algorithm may be based on a motion vector received by the mode decision unit 310, as described above. The motion vector received by the mode decision unit 310 may be associated with two or more video frames, such as a group of pictures (GOP) included in the video stream. Once a relatively high degree of motion is detected in the video stream, the encoder 230 may process the video frames by applying a predictive compression algorithm in order to generate a compressed video stream that includes P-frames, but not B-frames.

In some embodiments, the mode decision unit 310 may determine that a motion vector (e.g., an average motion vector) received from the motion search unit 320 has reached a threshold level and, in response, determine that the encoder 230 should switch to a predictive compression algorithm when encoding the video frames (e.g., a GOP) associated with the motion vector. The threshold value may correspond to the search range of the motion search unit 320. For example, if the motion search unit 320 performs a motion search within a range of 32×32 pixels, then the threshold value may be a motion vector of approximately 16 pixels. Selecting the threshold level in this manner may ensure that the encoder 230 will disable B-frame encoding when the degree of motion in the video stream is too high to accurately detect and encode similarities between a current video frame and preceding and/or subsequent video frames referenced by the current video frame.

FIG. 6 is a flow diagram of method steps for adaptively compressing video frames, according to one embodiment of the present invention. Although the method steps are described in conjunction with the systems of FIGS. 1-5, persons skilled in the art will understand that any system configured to perform the method steps, in any order, falls within the scope of the present invention.

As shown, a method 600 begins at step 610, where the encoder 230 (and/or optional software encoder 130) receives a video frame to be encoded. In some embodiments, the video frame may be part of a group of pictures (GOP). At step 620, the motion search unit 320 performs a motion search to determine one or more motion vectors associated with the video frame. For example, the motion search unit 320 may perform a motion search by comparing one or more locations included in the video frame to one or more locations included a preceding video frame and/or subsequent video frame. After determining the one or more motion vectors for the video frame, at step 630, the encoder 230 determines whether the video frame is the last video frame included in the current GOP. If the video frame is not the last video frame included in the current GOP, then the method 600 returns to step 610, where an additional video frame included in the GOP is received.

If, at step 630, the video frame is the last video frame included in the current GOP, then the method 600 proceeds to step 640. At step 640, the encoder 230 determines (e.g., via the motion search unit 320 and/or the mode decision unit 310) an average motion vector associated with the video frames included in the video stream and/or GOP. An average motion vector may be determined by summing multiple motion vectors determined for the video frame and dividing the sum by the number of motion vectors. In other embodiments, an average motion vector may be computed by determining a highest motion vector for each video frame included in a GOP and computing the average of the highest motion vectors. In the same or other embodiments, the motion vectors may be determined by separately analyzing motion in an x-direction and a y-direction. For example, an average motion vector in the x-direction may be computed by determining a highest motion vector in the x-direction for each video frame included in a GOP and computing the average of the highest motion vectors in the x-direction. Similarly, an average motion vector in the y-direction may be computed by determining a highest motion vector in the y-direction for each video frame included in a GOP and computing the average of the highest motion vectors in the y-direction. In general, any statistical techniques may be used to determine the degree of motion associated with a particular video frame, video frames, or GOP.

Next, at step 650, the mode decision unit 310 determines whether the average motion vector(s) have reached a threshold level, such as a threshold motion vector. In some embodiments, the mode decision unit 310 may determine whether an average motion vector in the x-direction and/or an average motion vector in the y-direction have reached a threshold level. As described above, the threshold level may correspond to the search range of the encoder 230. For example, the threshold level may be approximately equal to the search range of the motion search unit 320. If the average motion vector(s) have reached the threshold level, then the method 600 proceeds to step 660, where the encoder 230 encodes the video frame(s) and/or GOP using P-frames, and not any B-frames. The method 600 then proceeds to step 670, where the encoder 230 determines whether additional video frames (e.g., an additional GOP) is to be encoded by the encoder 230.

If the average motion vector(s) have not reached the threshold level, then the method 600 proceeds to step 665, where the encoder 230 encodes the video frame(s) and/or GOP using B-frames and, optionally, P-frames. In other embodiments, the decision of whether to use B-frames at step 650 may be applied to the next video frame(s) and/or GOP, instead of (or in addition to) the current video frame(s) and/or GOP. For example, if a high degree of motion is detected in a given GOP, B-frame encoding may be disabled when the encoder 230 encodes the next GOP.

The method 600 then proceeds to step 670, where the encoder 230 determines whether additional video frames are to be encoded by the encoder 230. If additional video frames are to be encoded by the encoder 230, then the method 600 returns to step 610, where another video frame is received. If no additional video frames are to be encoded by the encoder 230, then the method 600 ends.

In sum, an encoder receives an average motion vector, indicating an amount of motion in a video frame and/or group of pictures (GOP). The encoder then determines whether the average motion vector is above a threshold level. If the average motion vector is above (or equal to) the threshold level, then the encoder applies a first video compression algorithm, such as a video compression algorithm that encodes bi-directional frames (B-frames). If the average motion vector is below the threshold level, then the encoder applies a second video compression algorithm, such as a video compression algorithm that encodes predictive frames (P-frames), but not B-frames.

One advantage of the technique described herein is that a video compression algorithm can be dynamically selected based on an amount of motion detected in a video stream that is to be compressed. Accordingly, a high-quality image is maintained, even when there is a relatively high degree of motion in the video stream. Additionally, a higher-compression ratio algorithm may be selected and applied when there is a relatively low degree of motion in the video stream.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the present invention is set forth in the claims that follow.

What is claimed is:

1. A computer-implemented method for adaptively compressing video frames, the method comprising:
monitoring a motion vector associated with a video stream;
encoding a first plurality of video frames included in the video stream based on a first video compression algorithm to generate first encoded video frames;
determining that the motion vector has reached a threshold level;
in response, switching from the first video compression algorithm to a second video compression algorithm; and
encoding a second plurality of video frames included in the video stream based on the second video compression algorithm to generate second encoded video frames.

2. The method of claim 1, wherein the first video compression algorithm is configured to generate bi-directional video frames, and the second video compression algorithm is not configured to generate bi-directional video frames.

3. The method of claim 2, wherein the second video compression algorithm is configured to generate predictive video frames and intra video frames.

4. The method of claim 1, wherein the first plurality of video frames comprises a first group of pictures, and the second plurality of video frames comprises a second group of pictures.

5. The method of claim 1, wherein the motion vector comprises an average motion vector that is based on a first motion vector associated with a first video frame included in the video stream and a second motion vector associated with a second video frame included in the video stream.

6. The method of claim 1, wherein the threshold level is based on a search range of a video encoder.

7. The method of claim 6, wherein the search range is approximately 16 pixels.

8. The method of claim 1, further comprising:
determining that the motion vector has fallen below the threshold level;
in response, switching from the second video compression algorithm back to the first video compression algorithm; and
encoding a third plurality of video frames included in the video stream based on the first video compression algorithm to generate third encoded video frames.

9. The method of claim 1, wherein the first plurality of video frames and the second plurality of video frames comprise sequential groups of pictures.

10. A computing device, comprising:
a memory; and
a video encoder coupled to the memory and configured to adaptively compress video frames by:
monitoring a motion vector associated with a video stream;
encoding a first plurality of video frames included in the video stream based on a first video compression algorithm to generate first encoded video frames;
determining that the motion vector has reached a threshold level;
in response, switching from the first video compression algorithm to a second video compression algorithm; and
encoding a second plurality of video frames included in the video stream based on the second video compression algorithm to generate second encoded video frames.

11. The computing device of claim 10, wherein the first video compression algorithm is configured to generate bi-directional video frames, and the second video compression algorithm is not configured to generate bi-directional video frames.

12. The computing device of claim 11, wherein the second video compression algorithm is configured to generate predictive video frames and intra video frames.

13. The computing device of claim 10, wherein the first plurality of video frames comprises a first group of pictures, and the second plurality of video frames comprises a second group of pictures.

14. The computing device of claim 10, wherein the motion vector comprises an average motion vector that is based on a first motion vector associated with a first video frame included in the video stream and a second motion vector associated with a second video frame included in the video stream.

15. The computing device of claim 10, wherein the threshold level is based on a search range of the video encoder.

16. The computing device of claim 15, wherein the search range is approximately 16 pixels.

17. The computing device of claim 10, wherein the video encoder is further configured for:
determining that the motion vector has fallen below the threshold level;
in response, switching from the second video compression algorithm back to the first video compression algorithm; and
encoding a third plurality of video frames included in the video stream based on the first video compression algorithm to generate third encoded video frames.

18. The computing device of claim 10, wherein the first plurality of video frames and the second plurality of video frames comprise sequential groups of pictures.

19. A non-transitory computer-readable medium including instructions that, when executed by a processing unit, cause the processing unit to adaptively compress video frames, by performing the steps of:
monitoring a motion vector associated with a video stream;
encoding a first plurality of video frames included in the video stream based on a first video compression algorithm to generate first encoded video frames;
determining that the motion vector has reached a threshold level;
in response, switching from the first video compression algorithm to a second video compression algorithm; and
encoding a second plurality of video frames included in the video stream based on the second video compression algorithm to generate second encoded video frames.

20. The non-transitory computer-readable medium of claim 19, wherein the first video compression algorithm is configured to generate bi-directional video frames, and the second video compression algorithm is not configured to generate bi-directional video frames.
